(19) United States
(12) Patent Application Publication
(10) Pub. No.: US 2026/0001530 A1
(43) Pub. Date: Jan. 1, 2026

(54) AUTONOMOUS DRIVING VEHICLE AND A CONTROL METHOD THEREOF

(71) Applicants: HYUNDAI MOTOR COMPANY, Seoul (KR); KIA CORPORATION, Seoul (KR)

(72) Inventor: Hae Sung Nam, Hwaseong-si (KR)

(73) Assignees: HYUNDAI MOTOR COMPANY, Seoul (KR); KIA CORPORATION, Seoul (KR)

(21) Appl. No.: 18/951,057

(22) Filed: Nov. 18, 2024

(30) Foreign Application Priority Data
Jun. 27, 2024 (KR) 10-2024-0084836

(51) Int. Cl. B60W 30/09; B60W 50/14; B60W 60/00; G08G 1/16

(52) U.S. Cl. CPC B60W 30/09; B60W 50/14; B60W 60/0015; G08G 1/161; B60W 2556/65

(57) ABSTRACT

An autonomous driving vehicle includes a communication module mounted in the autonomous driving vehicle; and a processor that controls the communication module. In particular, the processor may determine whether a forward collision-avoidance assist (FCA) operation signal is received from a preceding vehicle that drives around the autonomous driving vehicle through a communication module. When the FCA operation signal is received, the processor may analyze the FCA operation signal and set a restriction mode that restricts driving of the autonomous driving vehicle based on the analyzed result value, and control driving of the autonomous driving vehicle based on the set restriction mode.

### CROSS-REFERENCE TO RELATED APPLICATION

The present application claims priority to Korean Patent Application No. 10-2024-0084836, filed on Jun. 27, 2024, the entire contents of which are incorporated herein by reference.

### TECHNICAL FIELD

The present disclosure relates to an autonomous driving vehicle and a control method thereof, and further relates to an autonomous driving vehicle and a control method thereof, which can control a forward collision-avoidance assist (FCA) function of an autonomous driving vehicle.

### BACKGROUND

The statements in this section merely provide background information related to the present disclosure and may not constitute prior art.

Autonomous driving vehicles in the related art operate the forward collision-avoidance assist (FCA) function based on given conditions (time to collision “TTC” and the like) through a forward camera, a forward radar sensor recognition during driving on a road.

The autonomous driving vehicle had difficulties in accurately predicting time to collision (TTC) with a preceding vehicle that drives ahead of the autonomous driving vehicle. For example, there was a problem in that, when the preceding vehicle operates a FCA emergency braking function, even if the autonomous driving vehicle avoids collision with the preceding vehicle, there was a high possibility of collision between following vehicles that drive behind the autonomous driving vehicle.

### SUMMARY

An object of the present disclosure is to provide an autonomous driving vehicle and a control method thereof. In particular, when a forward collision-avoidance assist (FCA) function occurs in a preceding vehicle, the autonomous driving vehicle and method can control such that the ego vehicle (i.e., the autonomous driving vehicle), which follows or drives behind the preceding vehicle, operates FCA in advance compared to the conventional ones.

Technical tasks that the present disclosure is to achieve are not limited to the technical tasks described above, and other technical tasks that have not been described should be clearly understood by those having ordinary knowledge in the technical field to which the present disclosure belongs from the description below.

To achieve the technical tasks described above, according to an embodiment of the present disclosure. A method of controlling a vehicle including a processor comprises: under control of the processor, receiving, by the processor, a forward collision-avoidance assist (FCA) operation signal from at least one other vehicle via a communication module; setting, by the processor, a restriction mode that restricts driving of the vehicle based on the FCA operation signal; and controlling, by the processor, the vehicle according to the set restriction mode.

In addition, the method may further include, under control of the processor, when the FCA operation signal is not received, determining that the at least one other vehicle is driving under normal conditions and setting, by the processor, the restriction mode to a zero restriction mode.

In addition, the method may further include, under control of the processor, setting the restriction mode into one mode among a first restriction mode, a second restriction mode, or a third restriction mode based on the FCA operation signal.

In addition, the method may further include, under control of the processor, when the first restriction mode is set, determining that braking of the at least one other vehicle is not operated and not restricting acceleration of the vehicle, and controlling the vehicle such that a warning notice is issued to a driver.

In addition, the method may further include, under control of the processor, when the second restriction mode is set, determining that braking of the at least one other vehicle is partially operated and controlling the vehicle such that acceleration of the vehicle is partially restricted.

In addition, the method may further include, under control of the processor, when the third restriction mode is set, determining that braking of the at least one other vehicle is entirely operated, and controlling the vehicle such that acceleration of the vehicle is entirely restricted.

In addition, the method may further include, under control of the processor, when the zero restriction mode or the first restriction mode is set, determining that braking of the at least one other vehicle is not operated and controlling the vehicle such that a time to collision (TTC) currently in use is continuously maintained.

In addition, the method may further include, under control of the processor, when the second restriction mode or the third restriction mode is set, determining that braking of the at least one other vehicle is operated and controlling the vehicle based on a new time to collision (TTC), which is different from a TTC currently in use.

In addition, the method may further include controlling driving of the vehicle at a time earlier than the TTC currently in use.

To achieve the technical tasks as described above, there is provided a non-transitory computer-readable recording medium storing instructions to control a vehicle. In one embodiment, the instructions, when executed by one or more processors, cause the one or more processors to: receive a forward collision-avoidance assist (FCA) operation signal from at least one other vehicle via a communication module, set a restriction mode in which driving of the vehicle is restricted based on the FCA operation signal, and control the vehicle according to the set restriction mode.

In another embodiment of the present disclosure, a vehicle includes: a communication module; a memory configured to store instructions; and a processor configured to execute the instructions. In particular, the instructions, when executed by the processor, cause the processor to: receive a forward collision-avoidance assist (FCA) operation signal from at least one other vehicle via the communication module, set a restriction mode in which driving of the vehicle is controlled or restricted based on the FCA operation signal, and control the vehicle according to the set restriction mode.

In addition, the instructions may further cause the processor to determine that the at least one other vehicle is driving under normal conditions and control the vehicle such that the restriction mode is set to a zero restriction mode when the FCA operation signal is not received.

In addition, the instructions may further cause the processor to set the restriction mode into one mode among a first restriction mode, a second restriction mode, or a third restriction mode based on the FCA operation signal.

In addition, the instructions may further cause the processor to determine that braking of the at least one other vehicle is not operated and not restrict acceleration of the vehicle, and control the vehicle such that a warning notice is issued to a driver when the first restriction mode is set.

In addition, the instructions may further cause the processor to determine that braking of the at least one other vehicle is partially operated and control the vehicle such that acceleration of the vehicle is partially restricted when the second restriction mode is set.

In addition, the instructions may further cause the processor to determine that braking of the preceding vehicle is entirely operated, and control the vehicle such that acceleration of the vehicle is entirely restricted when the third restriction mode is set.

In addition, the instructions may further cause the processor to determine that braking of the at least one other vehicle is not operated and control the vehicle such that a time to collision (TTC) currently in use is continuously maintained when the zero restriction mode or the first restriction mode is set.

In addition, the instructions may further cause the processor to determine that braking of the at least one other vehicle is operated and control the vehicle based on a new time to collision, which is different from the time to collision (TTC) currently in use, when the second restriction mode or the third restriction mode is set.

In addition, the new time to collision may include controlling driving of the vehicle at a time earlier than the time to collision currently in use.

The vehicle and the control method thereof according to an example of the present disclosure as configured described above controls such that an ego vehicle, which is a following vehicle that drives behind a preceding vehicle, operates FCA in advance compared to the existing one, when the forward collision-avoidance assist (FCA) of the preceding vehicle occurs, and thus can ensure additional collision safety, thereby preventing serial collisions of the following vehicles.

In addition, the vehicle and the control method thereof of the present disclosure operate warning and braking control of the forward collision-avoidance assist (FCA) function in advance at an appropriate time point, thereby improving driving reliability of the vehicle.

The effects that can be obtained in the present disclosure are not limited to the effects described above, and other effects that have not been described should be clearly understood by those having ordinary knowledge in the technical field to which the present disclosure belongs, from the description below.

### BRIEF DESCRIPTION OF THE DRAWINGS

FIG. 1 is a block diagram illustrating an autonomous driving vehicle according to an embodiment of the present disclosure.

FIG. 2 is a flowchart illustrating a method of driving of an autonomous driving vehicle according to an embodiment of the present disclosure.

FIG. 3 is a graph illustrating a method of controlling acceleration according to an embodiment of the present disclosure.

FIG. 4 is a graph illustrating a method of controlling TTC according to an embodiment of the present disclosure.

### DETAILED DESCRIPTION

Hereinafter, embodiments of the present disclosure are described in detail with reference to attached drawings so as to be easily carried out by those having ordinary knowledge in the technical field to which the present disclosure belongs to. However, the present disclosure can be obtained in various different forms and is not limited to specific embodiments described here. In addition, parts not related to the description are omitted in drawings to clearly describe the present disclosure, and like reference numerals are used for like portions throughout the present disclosure.

Throughout the present disclosure, when a portion “includes” an element, this means that the portion does not exclude other elements unless otherwise defined, and can further include other elements. In addition, those indicated by like reference numerals mean like elements.

In addition, “unit” and “control unit” included in names such as vehicle control unit (VCU) are only terms widely used in names of a controller that control a specific vehicle function, and do not mean a generic function unit. For example, each controller can include a communication device that communicates with other controllers or sensors to control its function, a memory that stores an operation system, logic commands, or input/output information, and one or more processors that carry out determination, calculation, decision, and the like required to control its function.

When a component, device, element, or the like of the present disclosure is described as having a purpose or performing an operation, function, or the like, the component, device, or element should be considered herein as being “configured to” meet that purpose or to perform that operation or function.

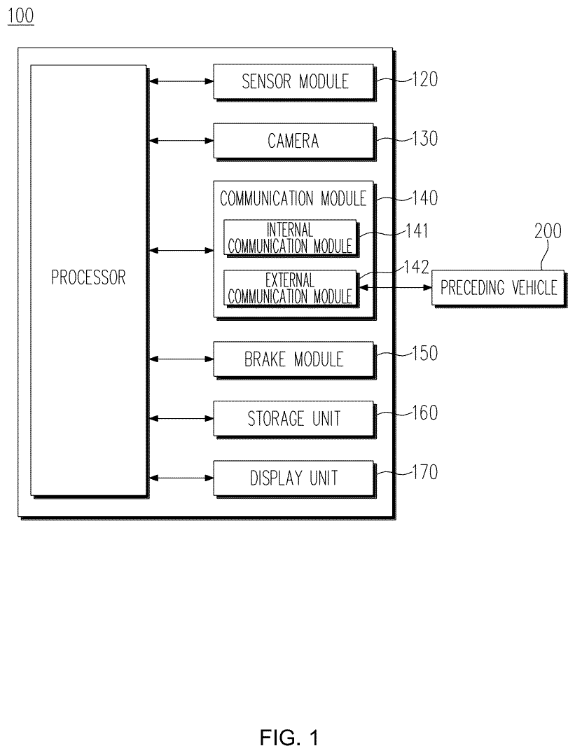

FIG. 1 is a block diagram to describe an autonomous driving vehicle according to an example of the present disclosure.

With reference to FIG. 1, an autonomous driving vehicle (100) according to an embodiment of the present disclosure may include a processor (110), a sensor module (120), a camera (130), a communication module (140), a brake module (150), a storage unit (160), and a display unit (170).

The processor (110) is disposed in the autonomous driving vehicle (100), is electrically connected to at least one or more parts, modules, and the like mounted in the autonomous driving vehicle (100), and can take overall control of the autonomous driving vehicle (100) while exchanging various data or signals by using at least one or more electrically connected parts, module, and the like and wired/wireless communication.

For example, elements of the autonomous driving vehicle (100) can exchange signals or data via an internal communication module (141) which is the communication module (140) of the autonomous driving vehicle (100) under control of the processor (110). In one embodiment, the internal communication module (141) of the autonomous driving vehicle (100) can include at least one communication protocol (for example, CAN, LIN, FlexRay, MOST, Ethernet, and the like).

The processor (110) can carry out control of the autonomous driving vehicle (100) by control of other elements mounted in the autonomous driving vehicle (100). For example, the processor (110) can carry out at least one function of engine management system (EMS), electronic stability control (ESC), electronic stability program (ESP), vehicle dynamic control (VDC), lane keeping assistance system (LKAS), smart cruise control (SCC), adaptive cruise control (ACC), autonomous emergency braking (AEB), forward collision-avoidance assist (FCA), highway driving assist (HDA), highway driving pilot (HDP), lane departure warning (LDW), driver awareness warning (DAW), or driver state warning (DSW). The functions described above can be referred to as advanced driver assist system (ADAS). Detailed description regarding the processor (110) is described below.

The sensor module (120) is mounted in the autonomous driving vehicle (100), and can sense at least one object positioned around the autonomous driving vehicle (100). Here, the object can include other vehicles (for example, forward vehicle, preceding vehicle (200), rear vehicle, and following vehicle), pedestrian, obstacle or transportation means (for example, bicycle, electric scooter, electric bicycle, motorcycle, and electric wheel).

For example, the sensor module (120) can precisely measure information on the object such as position of the object, distance from the autonomous driving vehicle (100) to the object, direction of the object separated from the autonomous driving vehicle (100), movement direction of the object, speed of the object, or the like using at least one or more sensors.

For example, the sensor module (120) can, under control of the processor (110), accurately detect changes in the positional relationship between the autonomous driving vehicle (100) and the object using at least one or more sensors. Here, the at least one or more sensors can include a radar sensor, a light detection and ranging (LiDAR) sensor, an infrared sensor, an ultrasonic sensor, a laser sensor, and the like. For example, the laser sensor can accurately measure the positional relationship between the autonomous driving vehicle (100) and the object by using time-of-flight (TOF), phase-shift, or the like depending on a laser signal phase-shift method.

The sensor module (120) can, under control of the processor (110), detect the object positioned in at least one area of forward, rear, left, and right of the autonomous driving vehicle (100) using at least one or more sensors. The at least one or more sensors can be mounted in various positions of the autonomous driving vehicle (100). For example, the at least one or more sensors can be mounted in at least one position among forward, rear, left, and right of the autonomous driving vehicle (100).

In addition, when there is a plurality of objects, the sensor module (120) can sense a plurality of objects simultaneously, but is not limited thereto. The sensor module (120) can, under control of the processor (110), sense the objects, and set a target object among the plurality of objects, considering the speed of the object, the distance between the object and the autonomous driving vehicle (100), the size of the object, and the like. The sensor module (120) can, under control of the processor (110), sense the set target object by priority compared to other objects, and track this.

The at least one or more sensors described above can include a heading sensor, a yaw sensor, a gyro sensor, a vehicle forward traveling/backward traveling sensor, a wheel sensor, a vehicle speed sensor, a vehicle body slope detection sensor, a battery sensor, a fuel sensor, a tire sensor, a sensor for steering by handle turning, a vehicle internal temperature sensor, a vehicle internal humidity sensor, or a door sensor.

The camera (130) can collect images of the surroundings of the autonomous driving vehicle (100) or images of the inside of the autonomous driving vehicle (100). At least one or more cameras (130) are mounted in the autonomous driving vehicle (100) and can collect images of the area ahead, images of the area behind, and images of the area at the lateral side of the autonomous driving vehicle (100).

The camera (130) can provide the processor (110) with the collected images. For example, the processor (110) can process stopped images or videos by analyzing the collected images through the camera (130), and extract required image information from the processed stopped images or videos.

In an embodiment, the camera (130) can include a charge coupled device (CCD) image sensor or a complementary metal oxide semiconductor (CMOS) image sensor. The camera (130) can include a three-dimensional space awareness sensor such as KINECT (RGB-D sensor), structured light sensor (TOF), and stereo camera (130).

The communication module (140) can communicate with at least one or more base stations, external devices, or other vehicles. Here, other vehicles can include a forward vehicle, a preceding vehicle (200), a rear vehicle, a following vehicle, and a side vehicle with respect to the autonomous driving vehicle (100) that drives.

The communication module (140) can, under control of the processor (110), receive driving information from other vehicles. The driving information can include position, speed, acceleration, direction, prediction path, path history, or forward collision-avoidance assist (FCA) signal (hereinafter, referred to as FCA operation signal (FRONT_FCA_ACT)) of other vehicles.

In one embodiment, the communication module (140) can include an internal communication module (141) and an external communication module (142).

The internal communication module (141) can carry out transmission or reception by using various communication protocols existing inside the autonomous driving vehicle (100). Here, the communication protocol can include at least one of controller area network (CAN), CAN with flexible data rate (CAN FD), Ethernet, local interconnect network (LIN), and FlexRay. The communication protocol can include other protocols for communication between various devices loaded in the vehicle.

The external communication module (142) can carry out vehicle-to-vehicle (V2V) communication with other vehicle or carry out vehicle-to-infrastructure (V2I) communication with an infrastructure. Here, the infrastructure can be a roadside unit or a server that regularly transmits transportation information by interworking with transportation information system (TIS) or intelligent transport system (ITS).

The external communication module (142) is not limited thereto, and can carry out vehicle-to-everything (V2X) communication. The external communication module (142) can use various communication methods such as vehicular ad hoc network (VANET), wireless access in vehicular environments (WAVE), dedicated short range communication (DSRC), communication access in land mobile (CALM), vehicle-to-network (V2N), wireless LAN (WLAN) communication, wireless-fidelity (Wi-Fi) communication, wireless broadband (WiBro) communication, long term evolution (LTE) communication, long term evolution-advanced (LTE-A) communication, 5G communication, 6G communication, ultrawideband (UWB) communication, ZigBee communication, and near field communication (NFC) communication.

The communication module (140) can include at least one of a transmission antenna, a reception antenna, and a radio frequency (RF) circuit and an RF element that can implement various communication protocols.

In addition, the communication module (140) can carry out communication with a terminal of a driver.

The brake module (150) can, under control of the processor (110), brake the autonomous driving vehicle (100) that drives. The brake module (150) can suddenly brake or gradually brake the autonomous driving vehicle (100) corresponding to a brake signal when a brake signal is provided, under control of the processor (110). Here, the brake signal can include a time-to-collision (TTC) signal (hereinafter, referred to as TTC signal) with a forward vehicle or a rear vehicle based on the autonomous driving vehicle (100) and an FCA operation signal (FRONT_FCA_ACT).

The brake module (150) can, under control of the processor (110), slowly reduce a speed of the autonomous driving vehicle (100) or suddenly stop the vehicle by selecting information on the FCA operation signal (FRONT_FCA_ACT) or the TTC signal in the control signal.

In one embodiment, the brake module (150) can include a plurality of wheel brakes (FL, FR, RL, and RR).

For example, the plurality of wheel brakes (FL, FR, RL, and RR) can include a first wheel brake (FL) that brakes a forward left wheel of the autonomous driving vehicle (100), a second wheel brake (FR) that brakes a forward right wheel of the autonomous driving vehicle (100), a third wheel brake (RL) that brakes a rear left wheel of the autonomous driving vehicle (100), and a fourth wheel brake (RR) that brakes a rear right wheel of the autonomous driving vehicle (100).

The plurality of wheel brakes can be installed corresponding to each wheel of the autonomous driving vehicle (100). For example, each of the plurality of wheel brakes (FL, FR, RL, and RR) can be independently braked, and can cause braking force in each wheel.

The storage unit (160) can be mounted in or separated from the autonomous driving vehicle (100). The storage unit (160) can store programs and information required for controlling the FCA function. The storage unit (160) can store information sensed by the sensor module, image information collected by the camera (130), information generated by the processor (110), or information received by the communication module (140). The storage unit (160) is not limited thereto. Here, the storage unit (160) can be referred to as a memory.

The display unit (170) can be mounted inside the autonomous driving vehicle (100). The display unit (170) can display a driving assist function related to the autonomous driving vehicle (100), under control of the processor (110). In one embodiment, the display unit (170) can include a cluster.

In one embodiment, when the preceding vehicle (200) suddenly reduces speed or a risk of collision with a vehicle that stops ahead, a pedestrian, a bicycle, and a passenger, the display unit (170) can, under control of the processor (110), display information related to this. The display unit (170) can issue a warning sound depending on the case.

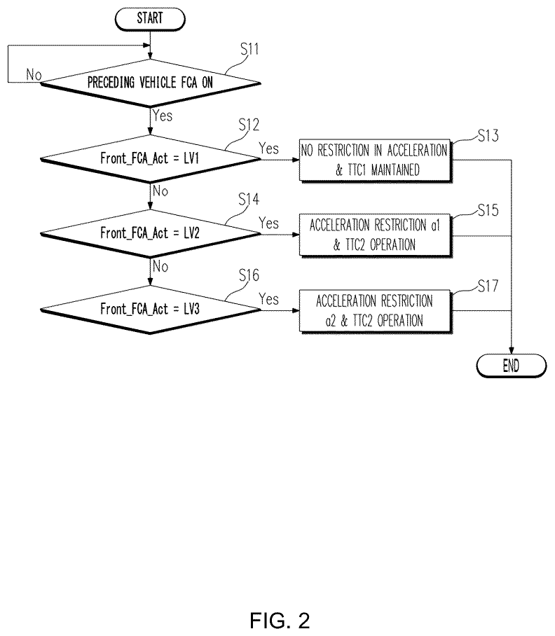

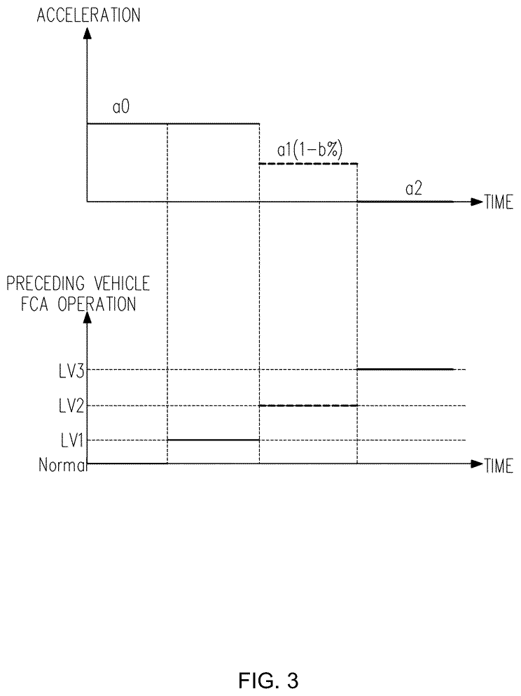

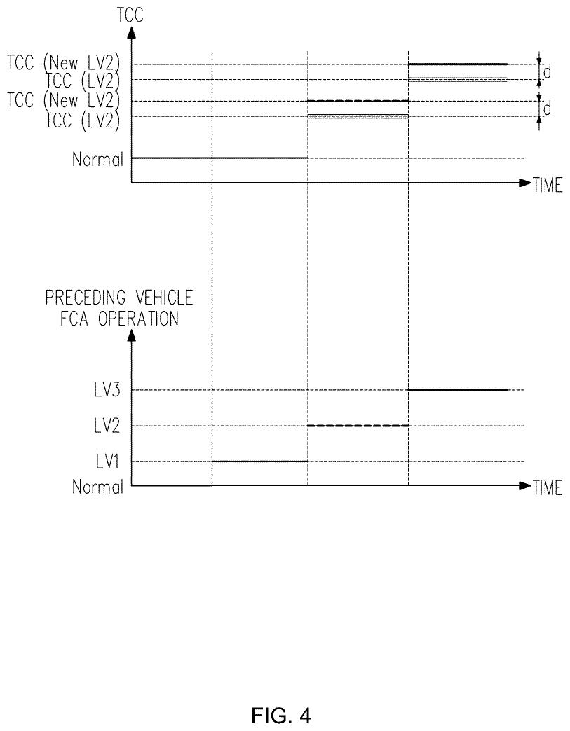

FIG. 2 is a flowchart illustrating a method of driving of an autonomous driving vehicle according to an embodiment of the present disclosure. FIG. 3 is a graph illustrating a method of controlling acceleration according to an embodiment of the present disclosure. FIG. 4 is a graph illustrating a method of controlling TTC according to an embodiment of the present disclosure.

With reference to FIG. 2, the method of driving of the autonomous driving vehicle (100) according to an embodiment of the present disclosure is as follows.

The autonomous driving vehicle (100) can, under control of the processor (110), determine whether a FCA operation signal (FRONT_FCA_ACT) is received from a nearby vehicle through the communication module (140) (S11).

For example, the autonomous driving vehicle (100) can, under control of the processor (110), when the FCA operation signal (FRONT_FCA_ACT) is not received from a nearby vehicle through the communication module (140), determine that it is in a normal mode. When the FCA operation signal (FRONT_FCA_ACT) is received, the autonomous driving vehicle (100) can determine that it is in a restriction mode. Here, the normal mode can be a state where a preceding vehicle (200) or a forward vehicle that drives ahead of the autonomous driving vehicle (100) normally drives (i.e., driving under its normal conditions). The normal mode can be referred to as level zero “0”.

The autonomous driving vehicle (100) can, under control of the processor (110), can receive an FCA operation signal (FRONT_FCA_ACT) from a nearby vehicle by utilizing a V2V antenna which is an external communication module (142).

Here, the nearby vehicle can refer to a preceding vehicle (200) or a forward vehicle that drives ahead of the autonomous driving vehicle (100) based on the autonomous driving vehicle (100), a following vehicle or a rear vehicle that drives behind the autonomous driving vehicle (100) based on the autonomous driving vehicle (100), and the like.

In other words, the autonomous driving vehicle (100) can, under control of the processor (110), collect information of the nearby vehicle by utilizing a V2V antenna which is an external communication module (142). The autonomous driving vehicle (100) can, under control of the processor (110), transmit and receive a FCA operation signal (FRONT_FCA_ACT) while performing V2V communication with a nearby vehicle by utilizing a V2V antenna which is an external communication module (142) and a V2X base station installed on a road.

The autonomous driving vehicle (100) can, under control of the processor (110), transmit and receive a FCA operation signal (FRONT_FCA_ACT) from a preceding vehicle (200) through the V2V antenna which is an external communication module (142).

For example, when the FCA operation signal (FRONT_FCA_ACT) is received from the preceding vehicle (200) through the communication module (140), the autonomous driving vehicle (100) can, under control of the processor (110), analyze the received FCA operation signal (FRONT_FCA_ACT) and set a restriction mode that can restrict driving of the autonomous driving vehicle (100) based on the analyzed result value (in steps S12, S14, S16). At this time, the restriction mode can be set to at least one or more.

In other words, the autonomous driving vehicle (100) can, under control of the processor (110), analyze the received FCA operation signal (FRONT_FCA_ACT), and set at least one or more restriction modes depending on the pre-set restriction range. The restriction mode can be set to a first restriction mode (LV1), a second restriction mode (LV2), and a third restriction mode (LV3). Here, the restriction mode can be referred to as a danger mode or a warning mode.

For example, the zero restriction mode can be a normal mode and referred to as level zero “0” (LV0). The zero restriction mode can be a normal state where the preceding vehicle (200) drives under normal conditions.

The autonomous driving vehicle (100) can, under control of the processor (110), perform normal control without restricting acceleration by determining that it is a normal mode in a case of the zero restriction mode.

The first restriction mode (LV1) can be a warning mode and referred to as level 1 (LV1). As a result of analysis of the received FCA operation signal (FRONT_FCA_ACT), the processor (11) can determine that the first restriction mode (LV1) is a state where forward collision warnings (FCW) of the preceding vehicle (200) are operated (in the step S12). The autonomous driving vehicle (100) can, under control of the processor (110), issue a warning notice to a driver in a case of the first restriction mode (LV1).

In other words, in the case of the first restriction mode (LV1), the autonomous driving vehicle (100) can, under control of the processor (110), receive a FCA operation signal from the preceding vehicle (200), and be in a circumstance that the analyzed result value shows that the acceleration of the preceding vehicle (200) is zero “0”, the autonomous driving vehicle (100) issues a warning notice to a driver without restricting acceleration of the autonomous driving vehicle (in a step S13).

The second restriction mode (LV2) can be a partial restriction mode and referred to as level 2 (LV2). As a result of analysis of the received FCA operation signal (FRONT_FCA_ACT), the processor (110) can determine that the second restriction mode (LV2) is a state where braking of the preceding vehicle (200) is operated and partial braking is operated (in the step S14).

In the case of the second restriction mode (LV2), since the mode is a state where the preceding vehicle (200) is partially braked, the autonomous driving vehicle (100) can, under control of the processor (110), partially restrict an accelerate pedal of the autonomous driving vehicle (100) (in a step S15).

In other words, in the case of the second restriction mode (LV2), in the autonomous driving vehicle (100), under control of the processor (110), the FCA operation signal analyzed from the preceding vehicle (200) can be −0.4 G or more and −0.7 G or less, which is within the pre-set restriction range, and the accelerate pedal of the autonomous driving vehicle (100) can be partially restricted corresponding to the deceleration of the preceding vehicle (200). Here, the deceleration of the preceding vehicle (200) can be set to a pre-set deceleration. The pre-set deceleration can be set to a tunable deceleration considering the performance and the like of the preceding vehicle (200) based on the preceding vehicle (200).

The third restriction mode (LV3) can be a full restriction mode and referred to as level 3 (LV3). As a result of analysis of the received FCA operation signal (FRONT_FCA_ACT), the processor (110) can determine that the third restriction mode (LV3) is a state where braking of the preceding vehicle (200) is operated and full braking is operated (in the step S16).

In the case of the third restriction mode (LV3), since the mode is a state where the preceding vehicle (200) is fully braked, the autonomous driving vehicle (100) can, under control of the processor (110), restrict an accelerate pedal of the autonomous driving vehicle (100) (in a step S17).

In other words, in the case of the third restriction mode (LV3), in the autonomous driving vehicle (100), under control of the processor (110), the FCA operation signal analyzed from the preceding vehicle (200) can be −0.8 G or more, which is within the pre-set restriction range, and the accelerate pedal of the autonomous driving vehicle (100) can be restricted corresponding to the deceleration of the preceding vehicle (200). Here, the deceleration of the preceding vehicle (200) can be set to a pre-set deceleration. The pre-set deceleration can be set to a tunable deceleration considering the performance and the like of the preceding vehicle (200) based on the preceding vehicle (200).

As described above, in the autonomous driving vehicle (100) according to an embodiment of the present disclosure, under control of the processor (110), time to collision (TTC) can vary by the pre-set restriction mode. The detailed description regarding this feature is described below.

As illustrated in FIG. 3, by analyzing the received FCA operation signal (FRONT_FCA_ACT), and applying the analyzed FCA operation signal (FRONT_FCA_ACT) to the pre-set restriction range, the autonomous driving vehicle (100) can, under control of the processor (110), set the first restriction mode to the third restriction mode.

The autonomous driving vehicle (100) can, under control of the processor (110), differently restrict acceleration with respect to the autonomous driving vehicle (100) based on the restriction mode set by the FCA operation signal (FRONT_FCA_ACT) of the preceding vehicle (200) or issue a notice to a driver.

For example, when the FCA operation signal (FRONT_FCA_ACT) is not received, the autonomous driving vehicle (100) can, under control of the processor (110), set the zero restriction mode. The zero restriction mode can be a normal state.

When the analyzed FCA operation signal (FRONT_FCA_ACT) is included within the first restriction range in the pre-set restriction range, the autonomous driving vehicle (100) can, under control of the processor (110), set the first restriction mode.

As a result of analysis of the received FCA operation signal (FRONT_FCA_ACT), the processor (110) can determine that the first restriction mode (LV1) is a state where forward collision warnings (FCW) of the preceding are operated, and issue a warning notice to a driver.

The zero restriction mode or the first restriction mode is a mode where there is no restriction in acceleration, and can be indicated as “a0”, as illustrated in FIG. 3.

In the case of the second restriction mode (LV2), since the mode is a state where the preceding vehicle (200) is partially braked, the autonomous driving vehicle (100) can, under control of the processor (110), partially restrict an accelerate pedal of the autonomous driving vehicle (100).

For example, in the case of the second restriction mode, the autonomous driving vehicle (100) can, under control of the processor (110), determine that the preceding vehicle (200) is in a state of FCA partial braking, and, when the accelerate pedal is operated at a % or less, control such that the accelerate pedal is operated at (1-b) %. Here, a and b can be values that can be set. Here, “a” can be set to 60, and “b” can be set to 30.

For example, in the case of the second restriction mode, the autonomous driving vehicle (100) determines, under control of the processor (110), that the preceding vehicle (200) is in a state of FCA partial braking, and, when the accelerate pedal is operated at 60% or more, can determine that the driver has an intention for acceleration and control not to proceed to FCA.

Unlike this, in the case of the second restriction mode, the autonomous driving vehicle (100) can, under control of the processor (110), determine that the preceding vehicle (200) is in a state of FCA partial braking, and, when the accelerate pedal is operated at 60% or less, can determine that the driver has no intention for acceleration and control such that the restriction in acceleration is substantially operated at 30%. The second restriction mode is a mode where there is partial restriction in acceleration, and can be indicated as “a1,” as illustrated in FIG. 3. Here, “a1” can be approximately between “a0” and “a2”. “a1” can be approximately medium or midpoint of a0 and a2.

In the case of the third restriction mode (LV3), since the mode is a state where the preceding vehicle (200) is fully braked, the autonomous driving vehicle (100) can, under control of the processor (110), restrict an accelerate pedal of the autonomous driving vehicle (100).

In the case of the third restriction mode, the autonomous driving vehicle (100) can, under control of the processor (110), determine that the preceding vehicle (200) is in a state of FCA full braking, and, when the accelerate pedal is operated at c % or more, can restrict its own acceleration. Here, “c” can be a value that can be set. Here, “c” can be set to 80.

For example, in the case of the third restriction mode, the autonomous driving vehicle (100) determines, under control of the processor (110), that the preceding vehicle (200) is in a state of FCA full braking, and, when the accelerate pedal is operated at 80% or more during FCA operation, FCA can be immediately cleared. As described above, in the case of the second restriction mode or the third restriction mode, the autonomous driving vehicle (100) according to an embodiment of the present disclosure can, under control of the processor (110), control such that only inertia and deceleration control is possible without additional acceleration in a state where accelerate pedal is operated.

As illustrated in FIG. 4, by analyzing the received FCA operation signal (FRONT_FCA_ACT), and applying the analyzed FCA operation signal (FRONT_FCA_ACT) to the pre-set restriction range, the autonomous driving vehicle (100) can, under control of the processor (110), set the first restriction mode to the third restriction mode.

When the zero restriction mode to the third restriction mode is set in the autonomous driving vehicle (100), time to collision (TTC) can vary, under control of the processor (110), based on the selected restriction mode.

For example, when the zero restriction mode or the first restriction mode is set, since there is no restriction in acceleration in the set zero restriction mode or the first restriction mode, the autonomous driving vehicle (100) can, under control of the processor (110), continuously maintain the time to collision (TTC) currently in use.

When the second restriction mode or the third restriction mode is set, since there is restriction in acceleration in the set second restriction mode or the third restriction mode, the autonomous driving vehicle (100) can, under control of the processor (110), set a new time to collision, not the time to collision (TTC) currently in use. Here, the time to collision currently in use can be referred to as TTC1 or existing TTC, and the new time to collision can be referred to as TTC2 or new TTC.

As illustrated in FIG. 4, the processor (110) can control such that the new TTC is operated earlier than the existing TTC. In other words, by controlling such that the new TTC is increased compared to the existing TTC so that the FCA function is operated at an earlier time, the autonomous driving vehicle (100) can, under control of the processor (110), ensure safe distance and braking distance.

The new TTC can be set as a value obtained by multiplying the existing TTC with (1+d) %. Here, “d” can be a value that can be set. Here, “d” can be set as 10.

For example, when TTC is advanced, by controlling such that the new TTC is operated 10% earlier than the existing TTC so that the FCA function is operated at an earlier time, the autonomous driving vehicle (100) can, under control of the processor (110), ensure safe distance and braking distance. As described above, the autonomous driving vehicle (100) and the control method thereof of the present disclosure control such that an ego vehicle, which is a following vehicle that drives behind a preceding vehicle, operates FCA or time to collision (TTC) in advance compared to the existing ones, when the forward collision-avoidance assist (FCA) of the preceding vehicle (200) occurs, and thus can ensure additional collision safety, thereby preventing serial collisions of the following vehicles.

In addition, the autonomous driving vehicle (100) and the control method thereof of the present disclosure operate a warning of the forward collision-avoidance assist (FCA) function and braking control of time to collision (TTC) at an appropriate time point, thereby improving driving reliability of the autonomous driving vehicle (100).

The present disclosure described above can be implemented as a computer-readable code on a medium on which a program is recorded. The computer-readable medium includes all kinds of recording devices in which data that can be read by a computer system is stored. Examples of the computer-readable media include hard disk drive (HDD), solid state disk (SSD), silicon disk drive (SDD), ROM, RAM, CD-ROM, magnetic tape, floppy disk, optical data storage device, and the like.

Therefore, the above detailed description should not be construed as being limited in every aspect, and should be considered as being exemplary. The scope of the present disclosure should be determined by reasonable interpretation of the attached claims, and all modifications within the equivalent scope of the present disclosure are included in the scope of the present disclosure.

What is claimed is:

1. A control method of a vehicle including a processor, comprising:
under control of the processor,
receiving, by the controller, a forward collision-avoidance assist (FCA) operation signal from at least one other vehicle via a communication module;
setting, by the controller, a restriction mode in which driving of the vehicle is restricted based on the FCA operation signal; and
controlling, by the controller, the vehicle according to the set restriction mode.

2. The control method of claim 1, further comprising:
under control of the processor,
when the FCA operation signal is not received, determining that the at least one other vehicle is driving under normal conditions and setting, by the processor, the restriction mode to a zero restriction mode.

3. The control method of claim 2, wherein setting the restriction mode comprising:
under control of the processor,
setting the restriction mode into one mode among a first restriction mode, a second restriction mode, or a third restriction mode based on the FCA operation signal.

4. The control method of claim 3, further comprising:
under control of the processor,
when the first restriction mode is set, determining that braking of the at least one other vehicle is not operated and not restricting acceleration of the vehicle, and controlling the vehicle such that a warning notice is issued to a driver.

5. The control method of claim 3, further comprising:
under control of the processor,
when the second restriction mode is set, determining that braking of the at least one other vehicle is partially operated and controlling the vehicle such that acceleration of the vehicle is partially restricted.

6. The control method of claim 3, further comprising:
under control of the processor,
when the third restriction mode is set, determining that braking of the at least one other vehicle is entirely operated, and controlling the vehicle such that acceleration of the vehicle is entirely restricted.

7. The control method of claim 3, further comprising:
under control of the processor,
when the zero restriction mode or the first restriction mode is set, determining that braking of the at least one other vehicle is not operated and controlling vehicle such that a time to collision (TTC) currently in use is continuously maintained.

8. The control method of claim 3, further comprising:
under control of the processor,
when the second restriction mode or the third restriction mode is set, determining that braking of the at least one other vehicle is operated and controlling the vehicle based on a new time to collision (TTC) which is different from a TTC currently in use.

9. The control method of claim 8, further comprising:
controlling driving of the vehicle at a time earlier than the TTC currently in use.

10. A non-transitory computer-readable recording medium storing instructions to control a vehicle, wherein the instructions, when executed by one or more processors, cause the one or more processors to:
receive a forward collision-avoidance assist (FCA) operation signal from at least one other vehicle via a communication module;
set a restriction mode in which driving of the vehicle is restricted based on the FCA operation signal; and
control the vehicle according to the set restriction mode.

11. A vehicle comprising:
a communication module;
a memory configured to store instructions; and
a processor configured to execute the instructions,
wherein the instructions, when executed by the processor, cause the processor to:
receive a forward collision-avoidance assist (FCA) operation signal from at least one other vehicle via the communication module,
set a restriction mode in which driving of the vehicle is restricted based on the FCA operation signal, and
control the vehicle according to the set restriction mode.

12. The vehicle according to claim 11,
wherein the instructions further cause the processor to determine that the at least one other vehicle is driving under normal conditions and set the restriction mode to a zero restriction mode when the FCA operation signal is not received.

13. The vehicle according to claim 12,
wherein the instructions further cause the processor to set the restriction mode into one mode among a first restriction mode, a second restriction mode, or a third restriction mode based on the FCA operation signal.

14. The vehicle according to claim 13,
wherein the instructions further cause the processor to determine that braking of the at least one other vehicle is not operated and not restrict acceleration of the vehicle, and control the vehicle such that a warning notice is issued to a driver when the first restriction mode is set.

15. The vehicle according to claim 13,
wherein the instructions further cause the processor to determine that braking of the at least one other vehicle is partially operated and control the vehicle such that acceleration of the vehicle is partially restricted when the second restriction mode is set.

16. The vehicle according to claim 13,
wherein the instructions further cause the processor to determine that braking of the preceding vehicle is entirely operated, and control the vehicle such that acceleration of the vehicle is entirely restricted when the third restriction mode is set.

17. The vehicle according to claim 13,
wherein the instructions further cause the processor to determine that braking of the at least one other vehicle is not operated and control such that a time to collision (TTC) currently in use is continuously maintained when the zero restriction mode or the first restriction mode is set.

18. The vehicle according to claim 13,
wherein the instructions further cause the processor to determine that braking of the at least one other vehicle is operated and control the vehicle based on a new time to collision (TTC), which is different form a TTC currently in use, when the second restriction mode or the third restriction mode is set.

19. The vehicle according to claim 18,
wherein the new TTC enables controlling driving of the vehicle at a time earlier than the TTC currently in use.
